(19) United States
(12) Patent Application Publication
(10) Pub. No.: US 2006/0289642 A1
(43) Pub. Date: Dec. 28, 2006

(54) Method of simulating an optical disk drive by a memory card and method of reading the memory card

(75) Inventors: Chin-Hsin Huang, Sindian City (TW); Kun-Hsien Chiang, Sindian City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Prescope Technologies Co., Ltd.

(21) Appl. No.: 11/267,506

(22) Filed: Nov. 7, 2005

(30) Foreign Application Priority Data
Jun. 25, 2005 (TW) 094121152

(51) Int. Cl. G06K 7/06; G06K 19/06

(52) U.S. Cl. 235/441; 235/492

(57) ABSTRACT

This invention describes a method of simulating an optical disk drive by a memory card, which is applied to a computer. The computer includes an operating system platform, and the memory card executes an auto-run program on the operating system platform like an optical disk drive. The method comprises the steps of: obtaining the capacity of said memory card; producing an ISO 9600 file system data on said memory card; computing the data length of a sector of said ISO 9660 file system data; computing the data length of a FAT section; producing the file system data of a FAT; loading said file system data of said FAT to said FAT section; and loading said ISO 9660 file system data to said ISO 9660 section. The invention also describes a method of reading the memory card having an auto-run function, and a card reading device for reading the memory card.

### BACKGROUND OF THE INVENTION

1. Field of the Invention

The present invention relates to a method of simulating an optical disk drive by a memory card, which is applied to a computer, and the computer includes an operating system platform, so that the memory card can execute an auto-run program on the operating system platform in a way similar to an optical disk drive. Further, the present invention also provides a method of reading the memory card that having the auto-run function, so that the memory card can be accessed by a general card reading device that has a FAT section, and the access or deletion of the ISO 9660 section can be prevented.

2. Description of the Related Art

The present removable storage device such as a flash memory with a USB interface which is similar to an optical disk drive having the function of executing an auto-run program, and thus if the USB flash memory is inserted into a USB slot of a computer that includes an auto-run program, then the computer will automatically execute the auto-run program, and a user can know the execution results easily.

As portable electronic products such as digital cameras become more popular, digital cameras usually comes with a memory slot for inserting a memory card for storing the pictures taken by the digital camera into the memory card. The common memory cards includes SmartMedia, CompactFlash, MMC, Security Digital (SD), Memory Stick, Memory Stick Pro, xD, Microdrive, Memory Stick Duo, or Memory Stick Pro Duo, etc. If it is necessary to read the content in the memory card, a common way is to insert the memory card into the slot of a card reader and connect the card reader to a personal computer to read the data.

However, general memory cards do not support the function of executing an auto-run program, and thus users have to execute the related operating procedure on the personal computer to access the content of the memory card. The memory cards of this sort are inconvenient to use.

### SUMMARY OF THE INVENTION

The primary objective of the present invention is to provide a method of simulating an optical disk drive by a memory card, so that the memory card can have the function of executing an auto-run program and improving the convenience of its operation.

Another objective of the present invention provides a method of reading a memory card that has an auto-run function to protect the data in the memory card from being erased by other compatible reading device and guarantee the integrity of user's data.

A further objective of the present invention is to provide a card reading device for reading the memory card and assuring the integrity of user's data.

To achieve the foregoing objectives, a method of simulating an optical disk drive by a memory card is applied to a computer, and the computer includes an operating system platform, so that the memory card can execute an auto-run program on the operating system platform in a way similar to the optical disk drive. The method comprises the steps of: obtaining the capacity of said memory card; producing an ISO 9600 file system data on said memory card; computing the data length of a section of the ISO 9660 file system data; computing the data length of a FAT section; producing the file system data of a FAT; loading the file system data of the FAT to the FAT section; and loading the ISO 9660 file system data to the ISO 9660 section.

To achieve the foregoing objectives, a method of reading a memory card having an auto-run function, which is applied to a card reading device, and the card reading device comprises a controller, a memory card slot, and a memory, and the method is executed by the controller, and the memory card comprises a FAT section or a FAT section and an ISO 9660 section. The method comprises the steps of: reading the content of a second logical block (LBA1) of the memory card; determining whether or not the string “LUN15” shows up in the second logical block (LBA1); if no, then memory card includes the FAT section and does not include the ISO 9660 section, and the FAT section of the memory card is obtained, and the card reading device can only access the FAT section of the memory card; if yes, then the memory card includes both the FAT section and the ISO 9660 section, and the FAT section of the memory card can be accessed; obtaining the length of the ISO 9660 section of the memory card; and the card reading device can simultaneously access the FAT section and the ISO 9660 section of the memory card.

To achieve the foregoing objectives, a card reading device of the invention comprises a controller, a memory card slot, and a memory, wherein the controller includes a firmware, and the firmware is executed to determine whether or not a memory card inserted in a memory card slot and identified by the card reading device has an ISO 9660 section; if the memory card has the ISO 9660 section, then the card reading device can access the data in the ISO 9660 section.

### BRIEF DESCRIPTION OF THE DRAWINGS

FIG. 1 is a schematic view of a memory card layout after a method of simulating an optical disk drive by a memory card of the present invention is applied;

FIG. 2 is a flow chart of a method of simulating an optical disk drive by a flash memory card according to a preferred embodiment of the present invention;

FIG. 3 is a schematic view of a structure of a FAT section according to the present invention;

FIG. 4 is a flow chart of a method of reading a memory card having an auto-run function according to the present invention;

FIG. 5 is a schematic block diagram of a reading device according to the present invention; and

Table 1 illustrates a structure of the information section of the invention.

### DETAILED DESCRIPTION OF THE PREFERRED EMBODIMENTS

The primary objective of the present invention is to produce a data format (more precisely an ISO9660) compatible to a general optical disk on a flash memory card. The invention intends to write user's data (usually several files) of the ISO 9660 format into a certain section of the flash memory card by certain specific software. If the flash memory card is read by a personal computer through a special device, the personal computer can accurately identify the existence of the optical disk drive and read the content without error. If the flash memory card is read by another compatible card reading device, the ISO 9660 data section will be hidden, which can prevent other users from destroying the data unintentionally. In addition, the sections other than the ISO 9660 of the flash memory card can be formatted into a FAT compatible format, so that users can save data freely in these sections.

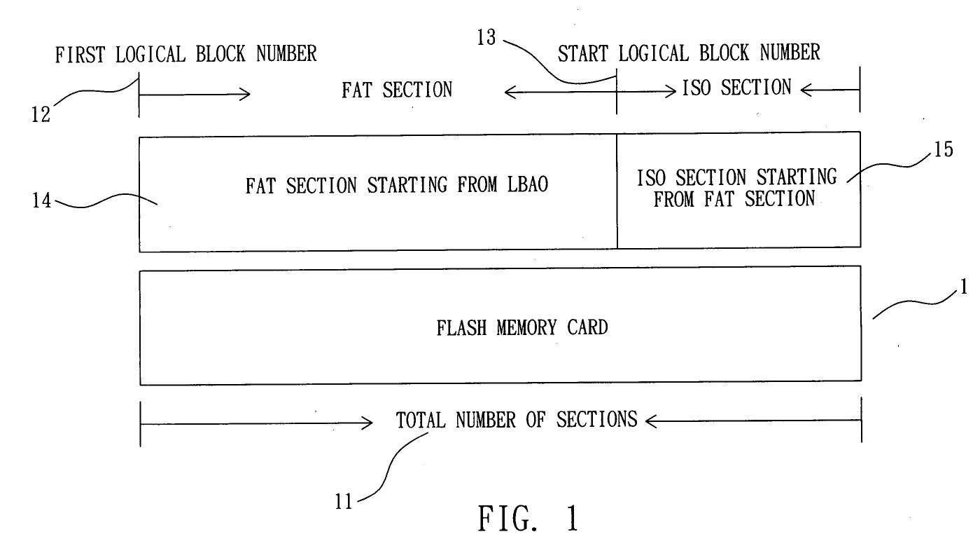

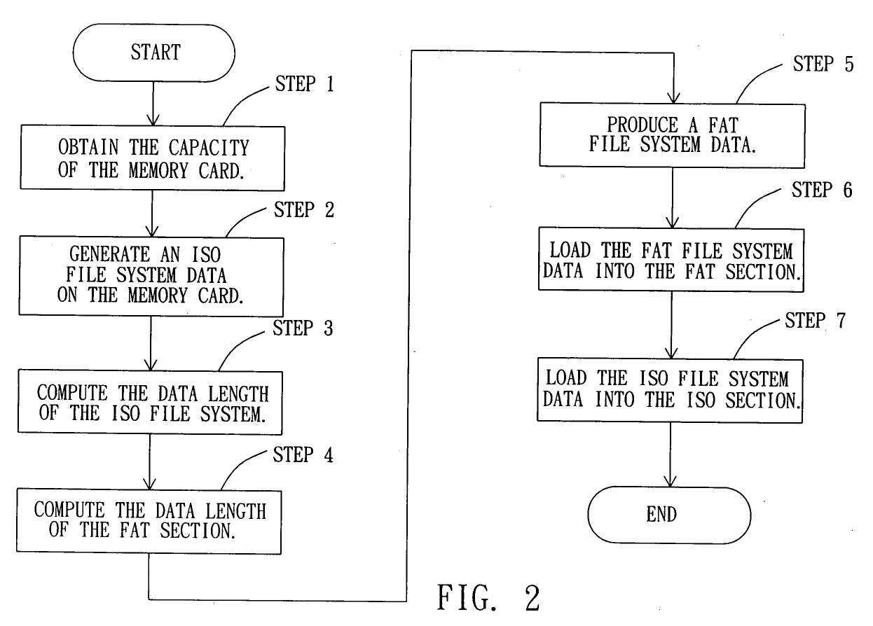

Referring to FIG. 1 for the schematic view of a memory card layout after a method of simulating an optical disk drive by a memory card of the present invention is applied, the memory card 1 simulates an optical disk drive by the method of the invention and the memory card 1 is divided into a number (TOT_SECTORS) 11 of physical sectors which represents the total number of physical sectors of the memory card 1, a first logical block number (LBA0) 12 which represents the first logical block number of the memory card 1, a start logical block number (LBAN) 13 which represents the start logical block number (LBAN=FAT_SECTORS) of the ISO 9660 section, a FAT section 14 which represents the number of physical sectors occupied by the FAT section, and an ISO 9660 section 15 which represents the number of physical sectors occupied by the ISO 9660 section.

Referring to FIG. 2 for the flow chart of a method of simulating an optical disk drive by a flash memory card according to a preferred embodiment of the present invention, the method of simulating an optical disk drive by a flash memory card is applied to a computer (not shown in the figure), and the computer includes an operating system platform such as a Window2000/XP operating system platform, so that the memory card 1 can execute an auto-run program in a way similar to the optical disk drive. The method comprises the steps of: (Step 1) obtaining the capacity of the memory card; (Step 2) producing an ISO 9600 file system data on the memory card 1; (Step 3) computing the data length of a section of the ISO 9660 file system data; (Step 4) computing the data length of a FAT section 14; (Step 5) producing the file system data of a FAT; (Step 6) loading the file system data of the FAT to the FAT section 14; and (Step 7) loading the ISO 9660 file system data to the ISO 9660 section 15.

In Step 1, the flash memory card 1 is a SmartMedia, a CompactFlash, a MMC, a Security Digital (SD), a Memory Stick, a Memory Stick Pro, an xD, or a Microdrive, a Memory Stick Duo, or a Memory Stick Pro Duo memory card.

In Step 2, the ISO 9660 file system data is produced by an ISO 9660 file system generating program (not shown in the figure), and the generated data is the ISO 9660 file system.

In Step 3, the data length of a section of the ISO 9660 file system data is computed.

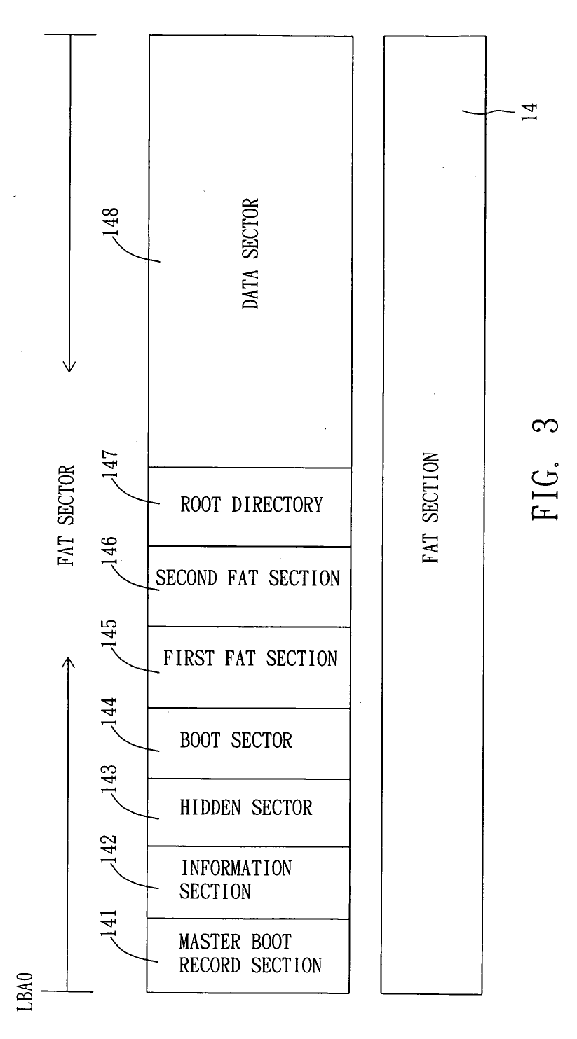

In Step 4, the data length of a FAT section 14 is computed, and the method of the present invention formats the sections other than the ISO 9660 file system data section as FAT compatible file system sections. Referring to FIG. 3 for the schematic view of a structure of the FAT section 14 of the invention, the FAT section 14 further comprises: a master boot record (MBR) section 141 including a sector length for storing a partition table of said memory card 1; an information (INFO) section 142 including a sector length for storing a FAT section and an ISO section of the memory card 1; and a hidden section 143 being reserved and having a sector length determined by the master boot record section 141.

In Step 5, the file system data of a FAT is generated by a FAT file system generating program (not shown in the figure).

In Step 6, the file system data of the FAT is loaded into the FAT section 14, and in Step 7, the ISO 9660 file system data is loaded into the ISO 9660 section 15.

After the ISO 9660 section 13 and the FAT section 14 are loaded in Steps 6 and 7, the ISO 9660 section 15 can be simulated as a general optical disk drive, and the data can be accessed like an optical disk drive. Therefore, if there is an auto-run program and the memory card 1 is connected to the computer, then the auto-run program will be started and executed automatically to facilitate users to access the memory card 1. Therefore, the method of simulating an optical disk by a memory card according to the present invention can definitely simulate the flash memory card 1 into an optical disk drive, so that the memory card 1 has the function of executing the auto-run program and overcome the shortcomings of the prior art memory card.

In addition, the method of reading a memory card having the auto-run function according to the present invention can protect the ISO 9660 section 15 of the memory card 1 from being erased by users and can assure the programs of the personal computer to be written into the FAT data section 14 and not into the ISO 9660 section 15. Simply speaking, the method of the invention uses the features of the master boot record section (MBR) 141 and the hidden section 143 in the FAT specification to restrict the range of writing in a program. The method adds a partition structure (which is a partition table entry; since it is a prior art, therefore the partition table entry will not be described here) in the master boot record section (MBR) 141. This structure marks the logical block number of boot sector 144 which gives the actual starting point of the FAT block and the size of the FAT section (or the FAT_SECTORS). If the system software of the personal computer detects the existence of this structure, the system software will access data in the range from the boot sector 143 to the FAT_SECTORS 14. Further, the firmware (installed in the controller and not shown in the figure) of the memory card reading device (not shown in the figure) has to know the starting point of the ISO 9660 section 15. For convenience, the information section (INFO) 142 records the size of the FAT_SECTORS 14 (the size of the FAT sector refers to the starting point of the ISO 9660 section) and the ISO_SECTORS 15 (or the size of the ISO 9660 section). Table 1 describes the structure of the information section (INFO) 142, and the information section 142 is further divided into a FAT-sector having a starting address of 0 and a length of 4 bytes for recording the size of the FAT section 14, an ISO 9660-sector having a starting address of 4 and a length of 4 bytes for recording the size of the ISO 9660 section 15; an unused area having a starting address of 8 and a length of 499 bytes, and an attributes area having a starting address of 507 and a length of 5 bytes for storing a string attribute of the “LUN15”. Further, the attributes area includes a hidden LUN07 attribute, and the LUN07 attributes can be used by certain specific software.

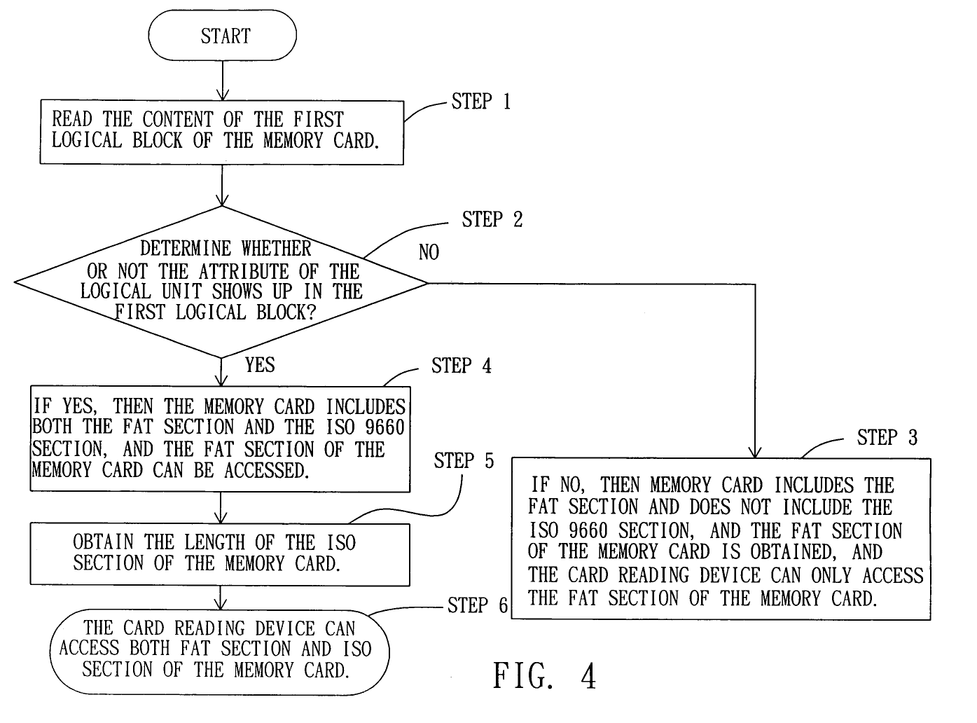

Referring to FIG. 4 for the flow chart of a method of reading a memory card having an auto-run function according to the present invention, the method of reading a memory card having an auto-run function is applied to a card reading device (not shown in the figure), and the card reading device comprises a controller (not shown in the figure), a memory card slot (not shown in the figure), and a memory 1, and the method is executed by the controller, and the memory card comprises a FAT section, or a FAT section and an ISO 9660 section. The method comprises the steps of: (Step 1) reading the content of a second logical block (LBA1) of the memory card; (Step 2) determining whether or not the string “LUN15” shows up in the second logical block (LBA1); (Step 3) if no, then the memory card includes the FAT section and does not include the ISO 9660 section, and the FAT section of the memory card is obtained, and the card reading device can only access the FAT section of the memory card; (Step 4) if yes, then the memory card includes both the FAT section and the ISO 9660 section, and the FAT section 14 of the memory card can be accessed; (Step 5) obtaining the length of the ISO 9660 section of the memory card; (Step 6) and the card reading device can simultaneously access the FAT section and the ISO 9660 section of the memory card.

In Step 1, the content of the second logical block (LBA1) of the memory card 1 is read, and the second logical block (LBA1) refers to the content of the information section (INFO) 142, and the content is shown in Table 1.

In Step 2, this step determines whether or not the string attribute “LUN15” shows up in the second logical black (LBA1) as shown in Table 1, which is located at the starting address 507 with a length of 5 bytes for storing the attribute of the “LUN15”. If the string attribute of “LUN15” is in the address 507-511, then the memory card 1 has an ISO 9660 section 15.

In Step 3, if the “LUN15” is not in the address 507-511, then the memory card 1 has the FAT section 14 only and not the ISO 9660 section 15. In the meantime, the FAT section 14 of the memory card 1 is obtained, and the card reading device can only access the FAT section of the memory card. In Step 3, the logical unit number (LUN)0 is used for reading the FAT section 14 having a starting point of LBA0and its size is recorded in the FAT-sector (as shown in Table 1).

In Step 4, if the string attribute of “LUN15” is in the address 507-511, then the memory card 1 includes both FAT section 14 and ISO 9660 section 15, and the card reading device can access the FAT section 14 of the memory card 1.

In Step 5, the card reading device will continue reading the length of the ISO 9660 section 15 of the memory card 1. Step 5 uses the logical unit number (LUN) 1 for reading the ISO 9660 section 15 with the starting point of LBAN, and the size is recorded in the ISO-sector (as shown in Table 1).

In Step 6, the card reading device can simultaneously access the FAT section 14 and the ISO 9660 section 15 of the memory card 1.

Further, the method for reading a memory card having an auto-run function further comprises an initialization step (Step 0), and if the initialization step does not find the ISO 9660 section 15, then the logical unit number (LUN)1 will be hidden.

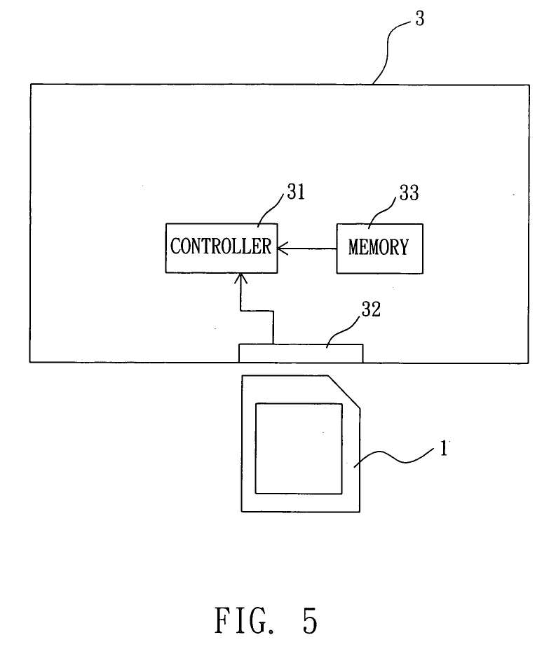

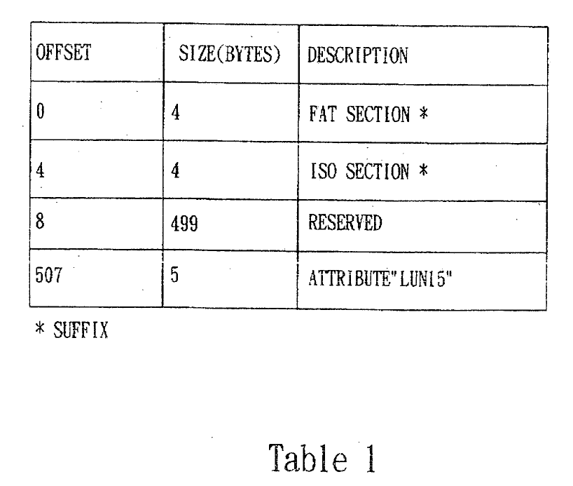

Referring to FIG. 5 for the schematic block diagram of a reading device of the present invention, the card reading device 3 comprises a controller 31, a memory card slot 32, and a memory 33, wherein the controller 31 includes a firmware (not shown in the figure), and the firmware includes the steps as shown in FIG. 4. Refer to FIG. 4 for its illustration, and these steps will not be described here. The controller 31 executes the firmware, so that the card reading device 3 can determine whether or not a memory card 1 inserted into the memory card slot 32 has an ISO 9660 section 15. If the memory card 4 includes the ISO 9660 section 15, then the card reading device 3 can access the data in the ISO 9660 section 15. For example, if the ISO 9660 section 15 includes an auto-run program, then the auto-run program will be executed automatically. If the memory card 4 has the FAT section 14 only, but not the ISO 9660 section 15, then the card reading device 3 will access the FAT section 14 like a general card reading device.

With the implantation of the method of reading a memory card having an auto-run function of the invention to the firmware in the controller 31 of the card reading device 3, the FAT section 14 and the ISO 9660 section 15 in the memory card having the auto-run function can be read. If the memory card 1 having the auto-run function is inserted into a compatible card reading device, the card reading device 3 will not be able to execute the auto-run function since the controller 31 of the card reading device 3 does not have the auto-run function, and the ISO 9660 section of the memory card 1 will be hidden and cannot be accessed. The invention protects data from being erased unintentionally by users, and thus it overcomes the shortcomings of the prior art memory cards and card reading devices.

With the present invention, the memory card is simulated as an optical disk drive, so that the memory card has the function of executing the auto-run program to facilitate its operation. In addition, the invention also can protect the data in the memory card from being erased by other compatible reading device, so as to assure the integrity of user's data, and overcome the shortcomings of the prior art memory cards and card reading devices.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of simulating an optical disk drive by a memory card, which is applied to a computer, and said computer includes an operating system platform, such that said memory card executes an auto-run program on said operating system platform in a way similar to said optical disk drive, and said method comprising the steps of:
obtaining the capacity of said memory card;
producing an ISO 9600 file system data on said memory card;
computing the data length of a sector of said ISO 9660 file system data;
computing the data length of a FAT section;
producing the file system data of a FAT;
loading said file system data of said FAT to said FAT section; and
loading said ISO 9660 file system data to said ISO 9660 section.

2. The method of claim 1, wherein said memory card is a flash memory card.

3. The method of claim 1, wherein said flash memory card is a SmartMedia, a CompactFlash, a MMC, a Security Digital (SD), a Memory Stick, a Memory Stick Pro, an xD, or a Microdrive, a Memory Stick Duo, or a Memory Stick Pro Duo memory card.

4. The method of claim 1, wherein said operating system platform is a Window 2000/XP operating system platform.

5. The method of claim 1, wherein said step of producing an ISO 9660 file system data on said memory card produces said ISO 9660 file system data by said ISO 9660 file system.

6. The method of claim 1, wherein said step of producing a FAT file system data produces said FAT file system data by a FAT file system.

7. The method of claim 5, wherein said step of loading said FAT file system data to said FAT section and said step of loading said ISO 9660 file system data to said ISO 9660 section write said FAT file system data and said ISO 9660 file system data into said memory card through a logical unit number (LUN) 07.

8. The method of claim 1, wherein said FAT section in said step of computing the data length of a FAT section comprises:
a master boot record, including a sector length for storing a partition table of said memory card;
an information section, including a sector length for storing a FAT section and an ISO section of said memory card; and
a hidden section, being reserved and having a sector length that is determined by said master boot record.

9. A method of reading a memory card that has an auto-run function, which is applied to a card reading device, and said card reading device comprises a controller, a memory card slot, and a memory, and said method is executed by said controller, and said memory card comprises a FAT section or a FAT section and an ISO 9660 section, said method comprising the steps of:
reading the content of a second logical block (LBA1) of said memory card;
determining whether or not the string “LUN15” shows up in said second logical block (LBA1);
if no, then said memory card includes said FAT section and does not include said ISO 9660 section, and said FAT section of said memory card is obtained, and said card reading device can only access said FAT section of said memory card;
if yes, then said memory card includes both said FAT section and said ISO 9660 section, and said FAT section of said memory card can be accessed;
obtaining the length of said ISO 9660 section of said memory card; and
said card reading device can simultaneously access said FAT section and said ISO 9660 section of said memory card.

10. The method of claim 9, wherein said memory card is a flash memory card.

11. The method of claim 10, wherein said flash memory card is a SmartMedia, CompactFlash, a MMC, a Security Digital (SD), a Memory Stick, a Memory Stick Pro, an xD, or a Microdrive, a Memory Stick Duo, or a Memory Stick Pro Duo memory card.

12. The method of claim 9, wherein said ISO 9660 section is an ISO 9660 file system data section.

13. The method of claim 9, wherein said FAT section comprises:
a master boot record, including a sector length for storing a partition table of said memory card;
an information section, including a sector length which is said second logical block, for storing a FAT section and an ISO 9660 section of said memory card; and
a hidden section, being reserved and having a sector length determined by said master boot record.

14. The method of claim 13, wherein said information section is divided into:
a FAT section, having a length of 4 bytes for recording the size of said FAT section;
an ISO section, having a length of 4 bytes for recording the size of said ISO 9660 section;
an unused area, having a length of 499 bytes; and
an attributes area, having a length of 5 bytes for storing a string attribute of said “LUN15”.

15. The method of claim 14, wherein said step of obtaining said FAT section of said memory card uses said logical unit number (LUN)0 for reading said FAT section, and its starting point is LBA0, and its size is stored in said FAT section.

16. The method of claim 14, wherein said step of obtaining said ISO 9660 section of said memory card uses said logical unit number (LUN)1 for reading said ISO 9660 section, and its starting point is LBAN and its size is stored in said ISO section.

17. The method of claim 16, further comprising an initialization step, if said initialization step does not find said ISO 9660 section, then said logical unit number (LUN)1 must be hidden.

18. The method of claim 13, wherein said attributes area further comprises a hidden LUN07 attribute, and said LUN07 attribute can be used in certain specific software only.

19. A card reading device, comprising a controller, a memory card slot, and a memory, wherein said controller includes a firmware, and said firmware is executed to determine whether or not a memory card inserted in a memory card slot identified by said card reading device has an ISO 9660 section; if said memory card has said ISO 9660 section, then said card reading device can access the data in said ISO 9660 section.

20. The card reading device of claim 20, wherein said firmware comprises the steps of:
determining whether or not said string attribute “LUN15” of said memory card shows up in said second logical block (LBA1);
if no, then memory card includes said FAT section and does not include said ISO 9660 section, and said FAT section of said memory card is obtained, and said card reading device can only access said FAT section of said memory card;
if yes, then said memory card includes both said FAT section and said ISO 9660 section, and said FAT section of said memory card can be accessed;
obtaining the length of said ISO 9660 section of said memory card; and
said card reading device can simultaneously access said FAT section and said ISO 9660 section of said memory card.

21. The card reading device of claim 20, wherein said memory card is a flash memory card.

22. The card reading device of claim 20, wherein said memory card is a SmartMedia, a CompactFlash, a MMC, a Security Digital (SD), a Memory Stick, a Memory Stick Pro, an xD or a Microdrive, a Memory Stick Duo, or a Memory Stick Pro Duo memory card.

23. The card reading device of claim 20, wherein said ISO 9660 section is an ISO 9660 file system data section.

24. The card reading device of claim 21, wherein said FAT section comprises:
a master boot record, including a sector length, for storing a partition table of said memory card;
an information section, including a sector length which is said first logical block, for storing a FAT section and an ISO section of said memory card; and
a hidden section, being reserved and having a sector length determined by said master boot record.

25. The card reading device of claim 25, wherein said information section is divided into:
a FAT section, having a length of 4 bytes for recording the size of said FAT section;
an ISO section, having a length of 4 bytes for recording the size of said ISO 9660 section;
an unused area, having a length of 499 bytes; and
an attributes area, having a length of 5 bytes for storing a string attribute of said “LUN15”.

26. The card reading device of claim 21, wherein said step of obtaining said FAT section of said memory card uses said logical unit number (LUN)0 for reading said FAT section, and its starting point is LBA0, and its size is stored in said FAT section.

27. The card reading device of claim 21, wherein said step of obtaining said ISO 9660 section of said memory card uses said logical unit number (LUN)1 for reading said ISO 9660 section, and its starting point is LBAN and its size is stored in said ISO section.

28. The method of claim 21, further comprising an initialization step, if said initialization step does not find said ISO 9660 section, then said logical unit number (LUN)1 must be hidden.

29. The method of claim 21, wherein said attributes area further comprises a hidden LUN07 attribute, and said LUN07 attribute can be used in certain specific software only.
